(19) United States
(12) Patent Application Publication
(10) Pub. No.: US 2015/0159580 A1
(43) Pub. Date: Jun. 11, 2015

(54) CONTROL DEVICE OF INTERNAL COMBUSTION ENGINE

(71) Applicant: Toyota Jidosha Kabushiki Kaisha, Toyota-shi Aichi-ken (JP)

(72) Inventor: Kazuhisa Matsuda, Susono-shi Shizuoka-ken (JP)

(21) Appl. No.: 14/559,173

(22) Filed: Dec. 3, 2014

(30) Foreign Application Priority Data
Dec. 9, 2013 (JP) 2013-254220

(51) Int. Cl. F02D 41/32; F02D 41/04

(52) U.S. Cl. CPC F02D 41/32; F02D 41/04

(57) ABSTRACT

A control device of an internal combustion engine of the invention is provided with: cooling fuel injection control means for controlling fuel injection through a fuel injection valve so as to inject cooling fuel through the fuel injection valve when a temperature of the fuel injection valve exceeds a predetermined temperature at a time when the internal combustion engine is stopped; and cooling fuel amount setting means for setting an amount of cooling fuel. The cooling fuel amount setting means sets the amount of cooling fuel of an open cylinder, which is a cylinder the intake valve of which is in an open state when the internal combustion engine is stopped, to be smaller than the amount of cooling fuel in another cylinder other than the open cylinder.

### INCORPORATION BY REFERENCE

The disclosure of Japanese Patent Application No. 2013-254220 filed on Dec. 9, 2013 including the specification, drawings and abstract is incorporated herein by reference in its entirety.

### BACKGROUND OF THE INVENTION

1. Field of the Invention

The invention relates to a control device of an internal combustion engine that has a plurality of cylinders and that is provided with fuel injection valves in respective intake ports of the cylinders.

2. Description of Related Art

Precise control of fuel injection in internal combustion engines allows enhancing fuel efficiency and improving exhaust emissions. For instance, the opening area of injection holes decreases and proper injection of fuel, in a desired amount, becomes difficult when deposits occur at the tips of fuel injection valves. Therefore, prevention of formation of deposits on the tips of fuel injection valves would be a desirable feature.

For instance, volatile components in the fuel that remains at the injection holes of the fuel injection valves vaporize, through heating, as the temperature of the fuel injection valves rises. As a result, generation and growth of deposits on fuel injection valves progress readily, whereupon low-volatility components in the fuel interact with exhaust gas components and the like. Accordingly, Japanese Patent Application Publication No. 2005-120983 (JP 2005-120983 A) discloses an internal combustion engine provided with fuel injection valves (in-cylinder fuel injection valves) that inject fuel directly into a combustion chamber, and wherein there is executed a process of increasing a target idle speed, performing single-stroke double injection, and switching from a stratified combustion mode to a homogeneous combustion mode, only for a predetermined period, in a low-load operation state immediately after high-load continuous operation, and lowering the temperature of the tips of the in-cylinder fuel injection valves, such as in prohibition of deceleration fuel-cutting. Generation and growth of deposits at the tips of the in-cylinder fuel injection valves of the internal combustion engine in JP 2005-120983 A are suppressed as a result.

### SUMMARY OF THE INVENTION

It is desirable herein to suppress or prevent formation of deposits also at the tips of fuel injection valves (port fuel injection valves) that inject fuel into an intake port. After stopping of the internal combustion engine, and in particular when the temperature of the internal combustion engine is high, such fuel injection valves for injection of fuel in intake ports receive radiant heat from intake valves and from the wall surfaces of the intake ports, and, accordingly, the temperature of the fuel injection valves tends to rise with time. A throttle valve of an intake passage is ordinarily closed at stop of the internal combustion engine, and hence the temperature of such fuel injection valves rises readily on account of the absence of flow of air at the intake port during stop of the internal combustion engine. This promotes as a result vaporization of residual fuel at the fuel injection valves. When there is also residual exhaust gas flowing back from the combustion chamber into the intake passage, exhaust gas components and fuel components interact with each other, due to heat. This tends to promote generation of deposits at the fuel injection valves.

The fuel injection valves may conceivably be cooled, through injection of fuel therethrough, so as to suppress generation and growth of such deposits, as in the internal combustion engine of JP 2005-120983 A. When fuel is injected through the fuel injection valves upon stop of the internal combustion engine, however, fuel flows into the cylinders the intake valves of which are open at the time of engine stop, which gives rise to the concern of worsened exhaust emissions in the next startup of the internal combustion engine.

Therefore, the invention suppresses more suitably formation of deposits on fuel injection valves at the time of stoppage of an internal combustion engine that has a plurality of cylinders and that is provided with fuel injection valves in respective intake ports of the cylinders.

In a control device for an internal combustion engine according to an aspect of the invention, the internal combustion engine includes a plurality of cylinders and fuel injection valves provided in respective intake ports of the cylinders, the control device having: an electronic control unit (ECU) configured to a) execute first fuel injection control when a temperature of the fuel injection valve exceeds a predetermined temperature, at a time when the internal combustion engine is stopped; and b) set a first fuel amount that is injected at the first fuel injection control, such that an amount of fuel injected into an open cylinder is smaller than an amount of fuel injected into a cylinder other than the open cylinder, the open cylinder being a cylinder whose intake valve is in an open state when the internal combustion engine stops.

The ECU may set the amount of fuel injected into the open cylinder based on a state of opening the intake valve of the open cylinder. The ECU may set a second fuel amount requested at startup of the internal combustion engine based on a coolant temperature of the internal combustion engine. The ECU may set the first fuel amount such that the first fuel amount is equal to or smaller than the second fuel amount.

The ECU may set the first fuel amount of the open cylinder such that inflow of fuel into the open cylinder is suppressed when the internal combustion engine stops. For instance, the ECU may set the first fuel amount of the open cylinder to zero.

The ECU may set a third fuel amount that is injected at startup of the internal combustion engine, such that the third fuel amount in each of the cylinders is equal to or smaller than a difference between the second fuel amount and a fuel amount that has already been injected through the fuel injection valve of the cylinder during a current stop of the internal combustion engine when a start request is made to the internal combustion engine; and the ECU may control fuel injection through the fuel injection valve such that fuel is injected with the third fuel amount thereby starting the internal combustion engine.

The ECU may operate a spark plug of each of the cylinders at least at one of an initial compression stroke and an initial expansion stroke of each of the cylinders when the internal combustion engine is started.

The ECU may store the number of times that the intake valve is in a closed state at stop of the internal combustion engine for each of the cylinders, and the ECU may perform control of stopping the internal combustion engine such that the intake valve of the cylinder is brought to a closed state when the internal combustion engine stops, the intake valve being in the closed state at stop of the internal combustion engine the smallest number of times.

In an aspect of the invention having the above configuration, the amount of cooling fuel in an open cylinder, the intake valve of which is in an open state when the internal combustion engine is stopped, is smaller than the amount of cooling fuel in cylinders other than the open cylinder, and cooling fuel is injected, in an relatively small amount, through the fuel injection valve of the open cylinder. Therefore, it becomes possible to reduce the content of unburned fuel and of incomplete combustion products of exhaust gas, in open cylinders, upon a subsequent startup of the internal combustion engine, and to prevent favorably exacerbated exhaust emissions while suppressing formation of deposits on the fuel injection valves that are provided in the intake ports.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of an internal combustion engine according to an embodiment of the invention;

FIG. 2 is a schematic diagram of one cylinder of the internal combustion engine of FIG. 1;

FIG. 3 is a graph illustrating conceptually the change in temperature at the tip of a fuel injection valve with respect to the lapse of time that an internal combustion engine has been stopped;

FIG. 4 is a graph illustrating conceptually a relationship between temperature reached at the tip of a fuel injection valve during stop of a internal combustion engine, and a decrease rate of the amount of injectable fuel with respect to a predetermined amount of fuel that would be injected through the fuel injection valve after the above temperature is reached;

FIG. 5A and FIG. 5B are a control flowchart of one embodiment;

FIG. 6 is a graph illustrating conceptually the relationship between coolant temperature and a startup requested fuel amount; and

FIG. 7 is a time chart illustrating conceptually an example of cooling fuel injection control at engine stop, in one embodiment.

### DETAILED DESCRIPTION OF EMBODIMENTS

An embodiment of the invention will be explained next with reference to accompanying drawings.

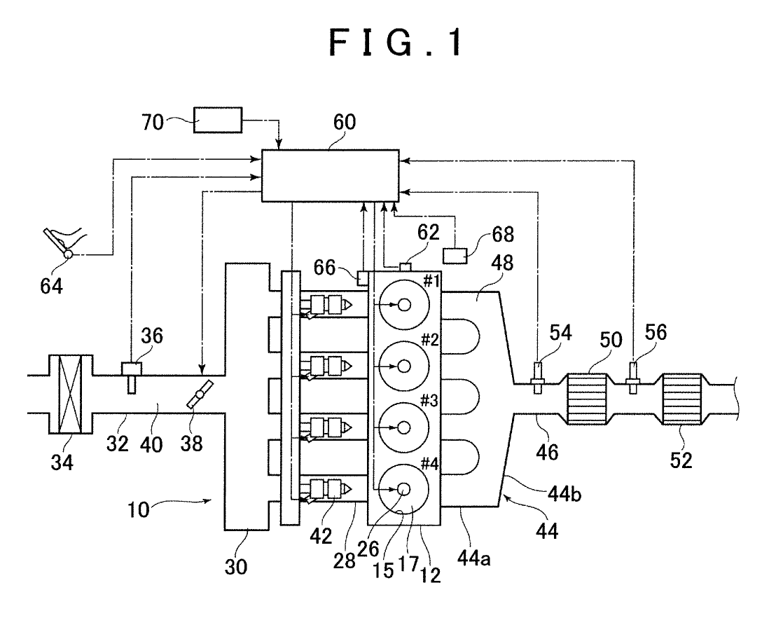

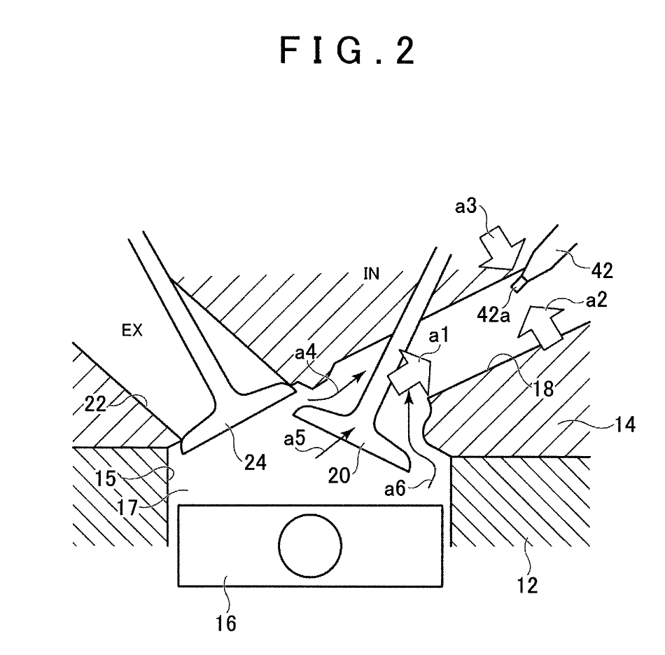

FIG. 1 is a schematic diagram of an internal combustion engine according to the present embodiment. FIG. 2 is a schematic diagram of one cylinder of the internal combustion engine of FIG. 1. An internal combustion engine (engine) 10 generates motive power through combustion of an air-fuel mixture of fuel and air inside combustion chambers 17, each of which is formed by a cylinder block 12, a cylinder head 14 and a piston 16 within a respective cylinder 15 of the cylinder block 12, and through reciprocation of the piston 16. The engine 10 of the present embodiment is an internal combustion engine having a plurality of cylinders, i.e. a multi-cylinder internal combustion engine, and more specifically a series four-cylinder spark-ignition internal combustion engine, installed a vehicle. The engine 10 has cylinders #1 to #4. The number, application, format and so forth of the cylinders are not particularly limited.

An intake valve 20 that opens and closes an intake port 18, and an exhaust valve 24 that opens and closes an exhaust port 22, are respectively disposed, in the cylinder head 14 of the engine 1, for each cylinder 15. The intake valves 20 and exhaust valves 24 are opened and closed by a camshaft not shown. A spark plug 26 for ignition of the air-fuel mixture in the combustion chamber 17 is attached to top of the cylinder head 14, for each cylinder 15. The spark plugs 26 are omitted in FIG. 2.

The intake port 18 of each cylinder is connected, via a branch pipe 28 of each cylinder, to a surge tank 30 that is an intake collecting chamber. An intake pipe 32 is connected to the upstream side of the surge tank 30. An air cleaner 34 is provided at the upstream end of the intake pipe 32. An air flow meter 36 for detecting an intake air amount, and a throttle valve 38 of electronic control type, are built into the intake pipe 32, in this order from the upstream side. The intake ports 18, the branch pipes 28, the surge tank 30 and the intake pipe 32 form respective partial divisions of the intake passage 40.

Fuel injection valves 42 are disposed in the intake passage 40, in particular in respective intake ports 18, for each cylinder. The fuel injection valves 42 are provided so as to inject fuel into the intake ports. The fuel injected through the fuel injection valves 42 is mixed with intake air to form an air-fuel mixture. This air-fuel mixture is taken into the respective combustion chamber 17 while the intake valve 20 is open, is compressed by the piston 16, and is caused to ignite and burn by the spark plug 26.

The exhaust port 22 of each cylinder is connected to the exhaust manifold 44. The exhaust manifold 44 is made up of a branch pipe 44a, for each cylinder, that constitutes the upstream section of the exhaust manifold 44, and is made up of an exhaust collecting section 44b that constitutes a downstream section. An exhaust pipe 46 is connected to the downstream side in the exhaust collecting section 44b. The exhaust ports 22, the exhaust manifold 44 and the exhaust pipe 46 form respective partial divisions of the exhaust passage 48.

An upstream catalyst converter 50 and a downstream catalyst converter 52, each having an exhaust purifying catalyst made up of a three-way catalyst, are serially attached to the exhaust pipe 46. A first and a second air-fuel ratio sensor, namely a pre-catalyst sensor 54 and a post-catalyst sensor 56, for detecting the air-fuel ratio in exhaust gas, are disposed on the upstream side and the downstream side, respectively, of the upstream catalyst converter 50. The pre-catalyst sensor 54 and the post-catalyst sensor 56, which are disposed at positions immediately before and directly after the upstream catalyst converter 50, can detect the air-fuel ratio on the basis of the oxygen concentration in the exhaust.

The above-described spark plugs 26, throttle valve 38, fuel injection valves 42 and so forth are electrically connected to an ECU 60 as a control means or control device. The ECU 60 is provided with, for instance, a central processing unit (CPU), a storage device including a read only memory (ROM) and a random access memory (RAM), and an input-output port, not of which is shown in the figures. In addition to the air flow meter 36, the pre-catalyst sensor 54 and the post-catalyst sensor 56 described above as illustrated in the figures, also a crank position sensor 62 for detecting the crank angle of the engine 10, an accelerator depression amount sensor 64 for detecting an accelerator depression amount, a water temperature sensor 66 for detecting the temperature of coolant (coolant temperature) of the engine 10, and a cam position sensor 68 attached to the camshaft, as well as other sensors, are electrically connected, via an analog-to-digital (A/D) converter, not shown, to the ECU 60. The ECU 60 controls the spark plugs 26, throttle valve 38, fuel injection valves 42 and so forth, on the basis of, for instance, the detected values from the outputs of the various sensors, in such a way so as to achieve a desired output, and controls likewise ignition timing, fuel injection amount, fuel injection timing, throttle opening and so forth. The ECU 60 is thus configured to substantially function as an ignition control means (ignition control unit), a fuel injection control means (fuel injection control unit), an intake air amount control means (intake air amount control unit) and an air-fuel ratio control means (air-fuel ratio control unit), and such that the foregoing means are associated with each other. Further, as will be made apparent in the explanation below, the ECU 60 is configured to substantially function as a cooling fuel injection control means (cooling fuel injection control unit), cooling fuel amount setting means (cooling fuel amount setting unit), startup fuel injection amount setting means (startup fuel injection amount setting unit), startup fuel injection control means (startup fuel injection control unit), number-of-times storage means (number-of-times storage unit), and stop control means (stop control unit), and these means associated with one another.

A throttle opening sensor (not shown) is provided in the throttle valve 38, such that an output signal of the throttle opening sensor is sent to the ECU 60. The ECU 60 performs ordinarily feedback control of bringing the degree of opening (throttle opening) of the throttle valve 38 to a target throttle opening established in accordance with the accelerator depression amount. The throttle valve 38 is closed, on the basis of an actuation signal from the ECU 60, when the engine 10 stops.

The ECU 60 detects the intake air amount per unit time on the basis of a signal from the air flow meter 36. The ECU 60 detects the load of the engine 10 on the basis of at least one from among the detected accelerator depression amount, throttle opening and intake air amount.

On the basis of a crank pulse signal from the crank position sensor 62, the ECU 60 detects the crank angle itself, and detects the revolutions of the engine 10 (revolutions per unit time), i.e. detects an engine rotational speed.

On the basis of the output of the crank position sensor 62 and the output of the cam position sensor 68, as a cylinder discrimination sensor, the ECU 60 calculates a fuel injection timing of each cylinder in accordance with an engine operating state detected as described above, calculates a fuel injection amount and ignition timing, and controls the fuel injection valves 42 and the spark plugs 26. The engine operating state can be expressed by engine load and the engine rotational speed.

The engine 10 is configured so that when the driver turns the key switch 70 on (when there is an engine (re)start request), the engine 10 receives a corresponding signal and starts, and when the switch 70 is turned off (when there is an engine stop request), the engine 10 receives a corresponding signal and stops. FIG. 2 illustrates conceptually the state of one cylinder 15 when the engine 10 stops. The intake valve 20 of the cylinder 15 in FIG. 2 is in an open state.

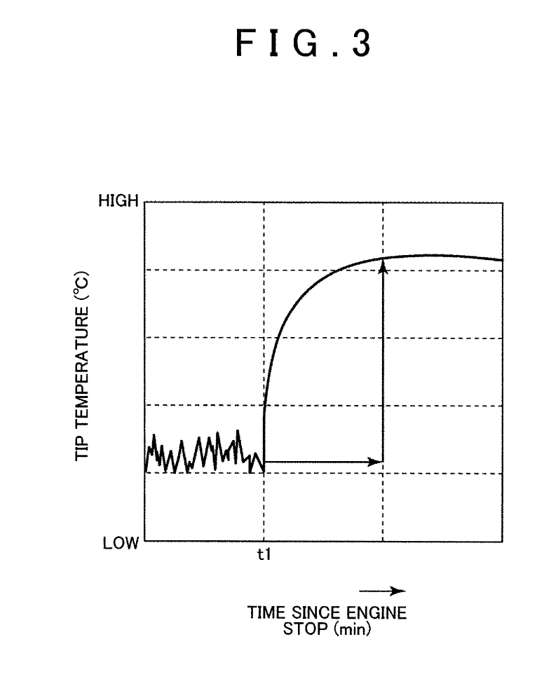

When the engine 10 stops in a high-temperature state, the fuel injection valves 42 is heated, and the temperature thereof rises, on account of the heat (radiant heat) from the intake valves 20 and the wall face of the intake ports 18 of large heat capacity, as denoted by the white arrows a1, a2 and a3 in FIG. 2. In particular, the fuel injection valves 42 are disposed in such a manner that tips (injection hole s) 42a thereof face the respective intake ports 18. Therefore, the tips 42a heat readily up with time. The throttle valve 38 is closed when the engine 10 stops, and there is no flow, or substantially no flow, of air into the intake port at engine stop. Therefore, the tips 42a of the fuel injection valves 42 heat readily up with time as a result of such engine stoppage. FIG. 3 is a graph illustrating conceptually the change in temperature of the tips 42a of the fuel injection valves 42 with respect to time elapsed since the engine 10 stops (time t1). The engine rotational speed becomes zero when the engine stops.

The temperature of the tips 42a of the fuel injection valves 42 is related to the coolant temperature of the engine, and to the time elapsed since stopping of the engine 10. Therefore, the temperature of the tips 42a of the fuel injection valves 42 can be calculated (detected) through searching of data that is set beforehand on the basis of experimentation based on of the coolant temperature of the engine and on the time elapsed since the engine 10 stops, or by performing computations on the basis of arithmetic expressions that are set in a similar manner.

Fuel volatile components that remain at the tips of the fuel injection valves 42 during stoppage of the engine 10, in particular in the injection holes, evaporate as the temperature of the fuel injection valves 42 rises. As indicated by arrows a4, a5 and a6 depicted in FIG. 2, residual exhaust gas from the interior of the cylinder may in some instances flow back into the intake passage. This exhaust gas may contain NOx, SOx, O₂, PM, HC and the like. Accordingly, deposits form readily on the fuel injection valves 42 as a result of interactions, for instance through oxidation by heating, between such exhaust gas components and low-volatile components (or non-volatile components) in the fuel.

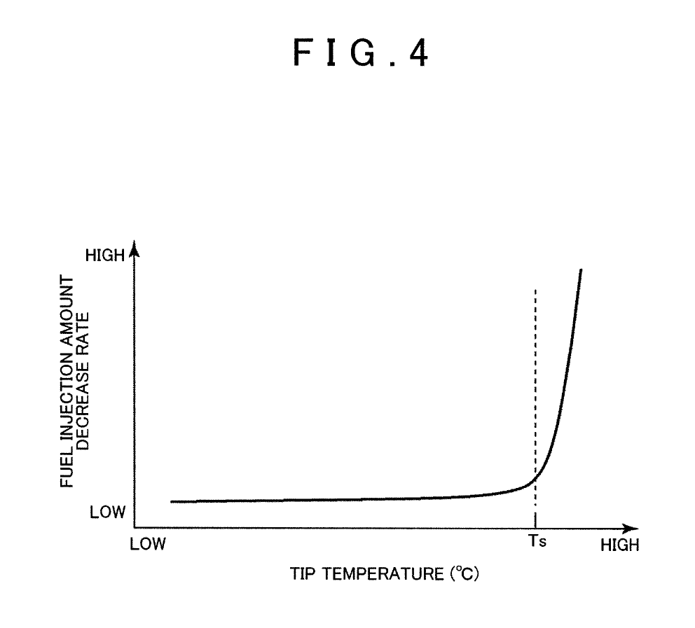

FIG. 4 illustrates conceptually a relationship between the temperature reached at the tip of a fuel injection valve during engine stop, and a decrease rate of the amount of injectable fuel with respect to a predetermined amount of fuel that would be injected through the fuel injection valve, after the above temperature is reached. The decrease rate corresponds roughly to the deposit formation amount on the fuel injection valve. In FIG. 4, the fuel injection amount decrease rate rises sharply when the temperature reached at the tip of the fuel injection valve becomes high, and in particular when the temperature exceeds a predetermined temperature Ts. As will be apparent from the above explanation and FIG. 4, formation of deposits in the injection hole of the fuel injection valve progresses as the temperature of the tip of the fuel injection valve rises. The opening area of the injection hole of the fuel injection valve decreases as a result, and fuel injection is accordingly hampered. Therefore, it would be desirable to suppress or prevent rises in temperature of the tips of the fuel injection valves 42, so as to suppress or prevent deposit formation, and prevent thereby fuel injection from being negatively affected by the deposit formation.

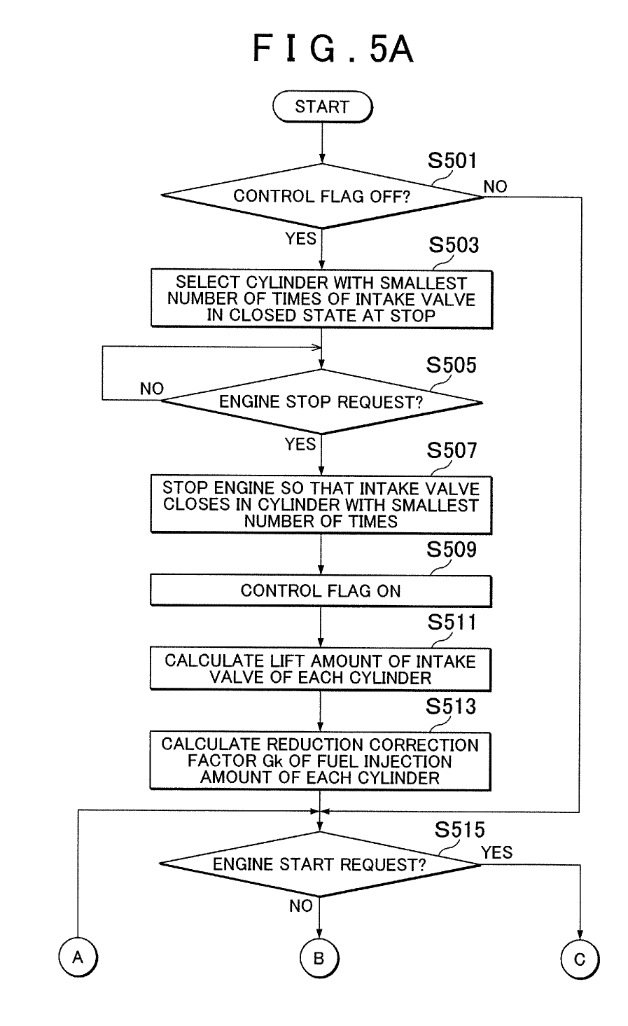

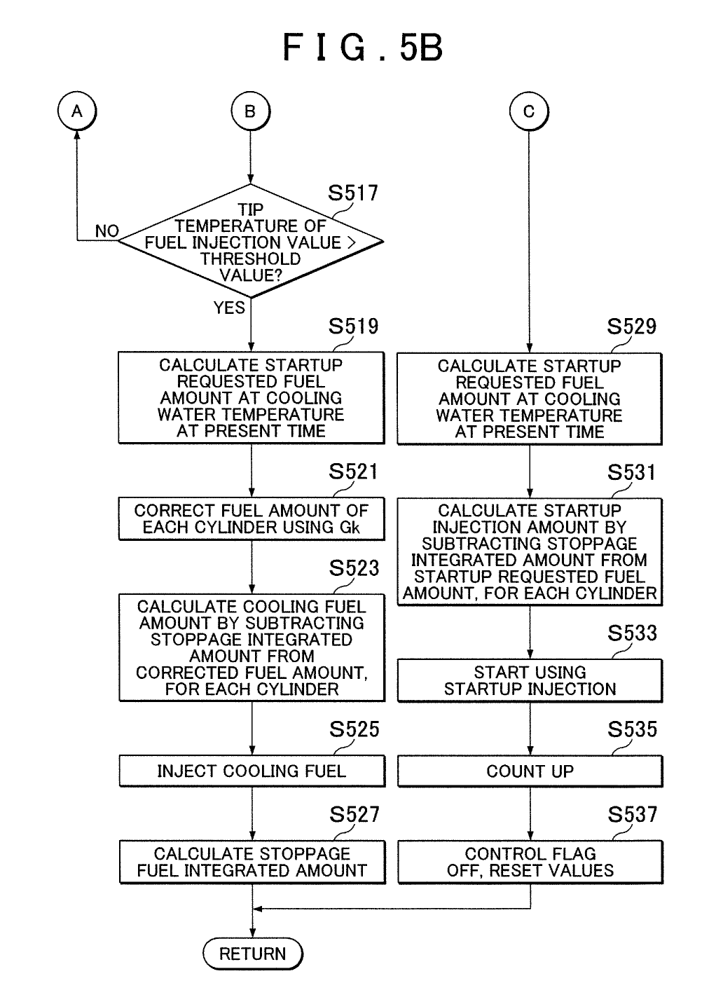

An explanation follows next, on the basis of the flowchart of FIG. 5 and FIG. 5B, on control for cooling the fuel injection valves at engine stop (cooling fuel injection control). The predetermined temperature Ts of FIG. 4 will be used as one reference in the control scheme explained on the basis of FIG. 5A and FIG. 5B. The predetermined temperature Ts in FIG. 4 is illustrated as being a lower-limit temperature of a temperature region in which deposit formation progresses rapidly, but a temperature lower than this lower-limit temperature (i.e. a temperature that leaves a given margin up to the lower-limit temperature) may be set herein as the predetermined temperature Ts. The predetermined temperature such as the predetermined temperature Ts is a temperature at which deposit formation is promoted when the temperature of the fuel injection valve exceeds that predetermined temperature, and hence may be referred to as an injector tip residual fuel oxidation-promoting temperature.

The ECU 60 determines in step S501 whether or not a control flag is off. The control flag is a flag that is turned on when the engine 10 stops while in operation, and is set to off in an initial state.

When step S501 yields an affirmative determination in that the control flag is off, in step S503 there is selected the cylinder, from among the four cylinders, with the smallest number of times that the intake valve thereof has been in a closed state at engine stop. The ECU 60 is provided with a counter that counts up when the intake valve is in a closed state at engine stop, for each cylinder. The ECU 60 detects thus the number of times that the intake valve of a given cylinder has been in a closed state at engine stop on the basis of this counter. The four counters are set to zero in an initial state, and increase in increments of 1. One or a plurality of cylinders, and preferably one cylinder, is selected in accordance with a priority order set beforehand, from among cylinders with an identical number of times of the intake valve having been in a closed state at engine stop.

The presence or absence of a stop request to the engine 10 is determined in subsequent step S505. Herein, the ECU 60 determines that there is a stop request to the engine 10 when there is inputted a signal denoting that the key switch has been turned from on to off. Step S505 is repeated until affirmative determination to the effect that there is a stop request to the engine 10.

Upon affirmative determination in step S505 to the effect that there is a stop request to the engine 10, the ECU 60 adjusts the crank angle and stops the engine 10 in step S507, in such a manner that there is closed the intake valve of the cylinder with the smallest number of times that the intake valve thereof has been in a closed state at engine stop, as selected in step S503 (in such a manner that the intake valve is brought to a closed state). This engine stop control may be accomplished for instance through fuel injection control or ignition control, or through control of an engine starter. Such engine stop control may be accomplished through throttle opening control halfway during engine stop, specifically through adjustment of the closed state of the throttle valve. Instead of relying on starter control, such engine stop control may be accomplished by adjusting the load of auxiliary equipment of the engine, for instance a generator (alternator), an oil pump, a water pump or the like. Preferably, there is closed the intake valve of a cylinder the intake valve of which was in an open state at a previous engine stop. The control flag is then turned on in step S509. The number of cylinders the intake valves of which are in an open state when the engine 10 stops (hereafter, “open cylinders”) may be one or plurality of cylinders, but is preferably one. Step S507 is executed by the ECU 60 functioning as a stop control means.

In subsequent step S511 there is calculated a lift amount of the intake valve of each cylinder. The ECU 60 detects (calculates) the lift amount of the intake valve of each cylinder on the basis of the output of the cam position sensor 68 and the output of the crank position sensor 62. This corresponds to detecting (identifying) open cylinders and detecting the lift amount of the intake valves of the open cylinders.

In subsequent step S513 there is calculated a reduction correction factor Gk of each cylinder. Herein, the correction factor Gk is calculated on the basis of the lift amount of an intake valve of each cylinder as calculated in step S511. Specifically, the correction factor Gk is calculated, on the basis of the lift amount of the intake valve of each cylinder, through searching of data that is set beforehand on the basis of experimentation, or through computation similarly set beforehand, in such a manner that the larger the lift amount of the intake valve, the more there is reduced a below-described startup requested fuel amount. In particular, such data and arithmetic expressions may be established in such a manner so as to suppress inflow of fuel into open cylinders while the engine is stopped. Herein, “1” is calculated as a correction factor Gkc of a cylinder the intake valve of which is in a closed state (hereafter referred to as “closed cylinder”). A value smaller than 1 is calculated as a correction factor Gknc of an open cylinder.

In subsequent step S515 it is determined whether or not there is a start request to the engine 10. The ECU 60 determines that there is a start request when there is inputted a signal denoting that the key switch has been turned from off to on.

Upon negative determination in step S515 to the effect that there is no start request, it is determined, in subsequent step S517, whether or not the temperature of the tip 42a of the fuel injection valve 42 (tip temperature) exceeds a threshold value (predetermined temperature). The fuel injection valve pertaining to the temperature that is to be determined in this step may be the fuel injection valve of any of the cylinders. The temperature of the tip 42a of the fuel injection valve 42 is calculated (detected) through search of data such as the one illustrated in FIG. 3, or through execution of a predetermined computation, on the basis of a coolant temperature Tw of the engine 10 as detected based on the output of the water temperature sensor 66, and on the basis of the time elapsed since the engine stopped as measured by a timer means (time measurement unit) the function of which is assumed by part of the ECU 60. The threshold value at step S517 is the predetermined temperature Ts of FIG. 4, but may be a temperature other than the predetermined temperature Ts, for instance a predetermined temperature lower than the predetermined temperature Ts. Upon negative determination in step S517, the process returns to step S515.

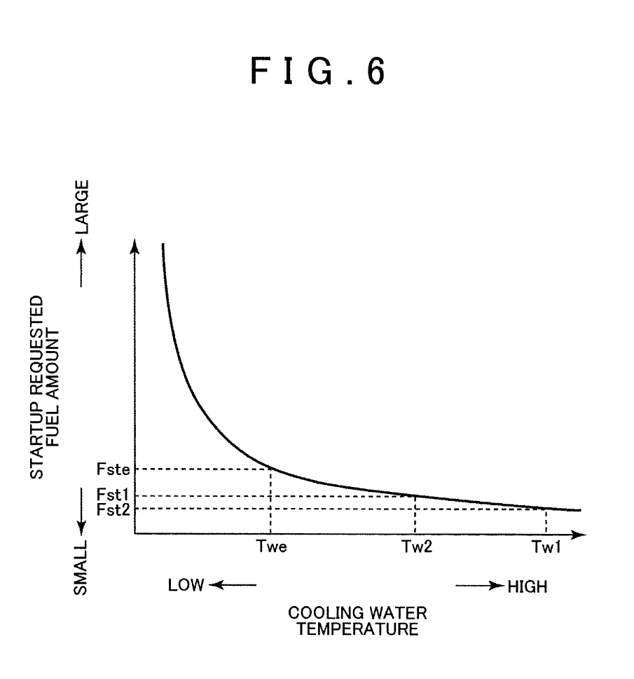

Upon affirmative determination in step S517 to the effect that the temperature of the tip 42a of the fuel injection valve 42 exceeds the threshold value, a startup requested fuel amount Fst at the coolant temperature at the present time (at that time) is calculated in step S519. The startup requested fuel amount is the fuel amount that is necessary for starting the engine at that time. The startup requested fuel amount is calculated through search of data that is set beforehand on the basis of experimentation, or through execution of computations using arithmetic expression similarly set, on the basis of the coolant temperature Tw of the engine 10 as detected based on the output of the water temperature sensor 66. The startup requested fuel amount is calculated here through search of data made into a graph as conceptually depicted in FIG. 6. Herein, FIG. 6 illustrates a relationship between the coolant temperature and the startup requested fuel amount, wherein the startup requested fuel amount increases as the coolant temperature decreases. Ordinarily, the coolant temperature drops gradually after the engine 10 stops. With the passage of time, therefore, the coolant temperature decreases and the calculated startup requested fuel amount increases.

In subsequent step S521, a corrected fuel amount is calculated for each cylinder using the correction factor Gk calculated in step S513. The corrected fuel amount for each cylinder is calculated on the basis of the startup requested fuel amount calculated in step S519. Herein, a corrected fuel amount CF of each cylinder is calculated by multiplying the startup requested fuel amount Fst calculated in step S519 by the correction factor Gk calculated in step S513 (CF=Fst×Gk). The correction factor Gkc in a closed cylinder is 1, and hence the startup requested fuel amount Fst calculated in step S519 remains as a corrected fuel amount CFc. In an open cylinder, the correction factor Gknc is smaller than 1, and hence an amount that is smaller than the startup requested fuel amount Fst calculated in step S519 is herein calculated as a corrected fuel amount CFnc.

In subsequent step S523 there is calculated an amount of cooling fuel (target injection amount) F for each cylinder. The term cooling fuel denotes herein fuel that is intended to be actually injected in order to cool the fuel injection valve. The amount of cooling fuel is obtained by subtracting a stoppage fuel integrated amount of each cylinder from the corrected fuel amount of that cylinder. The stoppage fuel integrated amount, which is calculated for each cylinder and is stored in a storage device, is a total fuel amount of cooling fuel during a current engine stop that has already been injected thus far, through the fuel injection valve, at each cylinder. The stoppage fuel integrated amount of all cylinders is zero when step S523 is arrived at for the first time during a current engine stop. The amount of cooling fuel is set by the ECU 60 functioning as a cooling fuel amount setting means.

In step S525, next, the cooling fuel is injected through the fuel injection valve of each cylinder, in the amount calculated in step S523 for each cylinder. The fuel injection valves 42 of the cylinders are cooled as a result by this fuel. Step S525 is executed by the ECU 60 functioning as the cooling fuel injection control means.

In subsequent step S527 there is calculated the stoppage fuel integrated amount for each cylinder, and the result is stored in the storage device of the ECU 60. The stoppage fuel integrated amount, which is calculated, updated and stored for each cylinder, is calculated and updated through addition of the amount of cooling fuel calculated in step S523 to the stoppage fuel integrated amount so far. This completes the current routine. The stoppage fuel integrated amount thus updated and stored can be used in step S523 and step S531 of a subsequent routine.

In the subsequent routine, the control flag is on; hence, step S501 yields a negative determination, and the process jumps to step S515. When there is no start request to the engine 10 (unless step S515 yields an affirmative determination), cooling fuel is injected in principle through the fuel injection valve of each cylinder, whenever the temperature of the tip of the fuel injection valve 42 exceeds a threshold value, as described above.

On the other hand, if step S515 yields an affirmative determination to the effect that there is an engine start request, the startup requested fuel amount at the coolant temperature at the present time is calculated in step S529. The startup requested fuel amount at the coolant temperature at the present time is calculated as explained in step S519, and hence the calculation will not be explained again.

In subsequent step S531 a startup fuel injection amount is calculated for each cylinder. The startup fuel injection amount is a fuel injection amount (target injection amount) intended to be actually injected through the fuel injection valve at engine startup. Herein, the startup fuel injection amount is calculated by subtracting the stoppage fuel integrated amount from the calculated startup requested fuel amount, calculated in step S529. As described above, fuel is already present in the intake passage or inside the cylinder, preferably only in the intake passage, upon injection of cooling fuel in order to cool the fuel injection valve, during engine stop. Thus, the remainder after deducting the already-injected fuel is calculated in step S531 as the startup fuel injection amount. The stoppage fuel integrated amount is different between closed cylinders and open cylinders, and hence the calculated startup fuel injection amount is likewise different. The stoppage fuel integrated amount is zero for all cylinders when no cooling fuel has been injected, even once, during engine stop. In this case, therefore, the startup requested fuel amount calculated in step S529 remains as-is, and constitutes the startup fuel injection amount at each cylinder in step S531, such that the startup fuel injection amount is identical for all cylinders. The startup fuel injection amount is set by the ECU 60 that functions thus as the startup fuel injection amount setting means.

In step S533 next, fuel is injected into the each cylinder in the startup fuel injection amount calculated in step S531, to start the engine. Step S533 is executed by the ECU 60 functioning as the startup fuel injection control means. The spark plug of each cylinder is thereupon operated at the initial compression stroke or initial expansion stroke, preferably the initial compression stroke after initiation of engine startup. The fuel or part thereof in the intake passages and in the cylinders is burned more effectively as a result.

In step S535, the counter of each cylinder the intake valve of which was in a closed state at engine stop i.e. a closed cylinder, increases in increments of 1. The counter of each open cylinder remains as-is. These counters are used in step S503. Step S535 is executed by the ECU 60 functioning as a number-of-times storage means that stores, for each cylinder, the number of times that the intake valve thereof has been in a closed state during stop of the engine.

The above control flag is turned off in step S537, and the various values are reset (set to zero). For instance, the stoppage fuel integrated amount is set to zero.

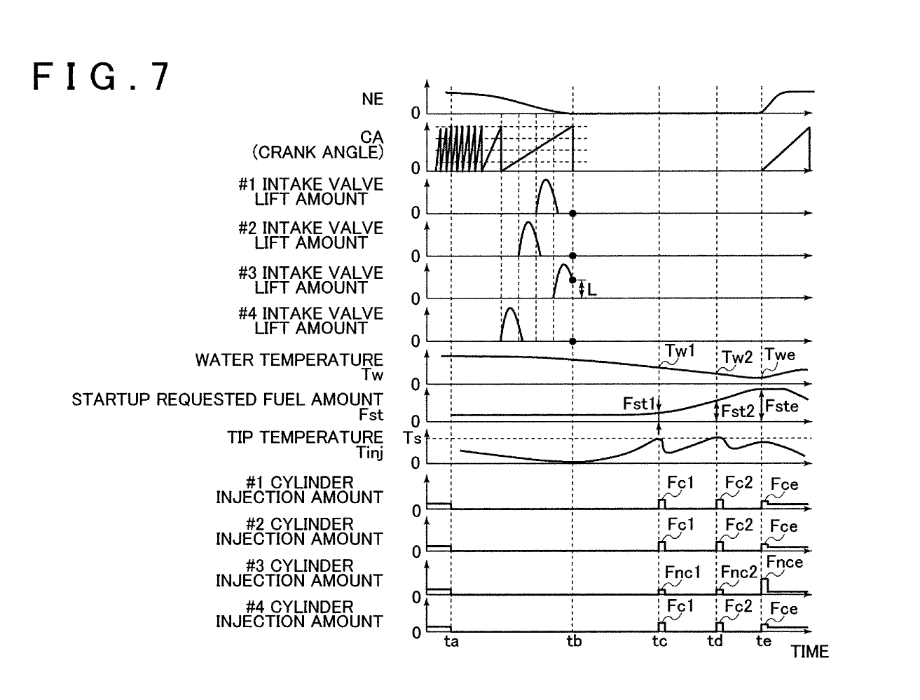

The cooling fuel injection control at engine stop explained based on the flowchart of FIG. 5A and FIG. 5B will be further explained on the basis of the graph of FIG. 6 and the time chart of FIG. 7. Herein, FIG. 7 illustrates conceptually an example of cooling fuel injection control at engine stop.

In FIG. 7, the engine 10 stops when there is an engine stop request at a point in time to (affirmative determination in step S505) in a state where the engine 10 is running At this time, for instance the cylinder with the smallest number of times of the intake valve having been in a closed state at engine stop is cylinder #1 (step S503), and hence the engine is stopped in such a manner that the intake valve of cylinder #1 closes (step S507). In the example of FIG. 7 the engine stops at a point in time tb (engine rotational speed NE reaches zero), with only the intake valve of cylinder #3 in an open state. As a result, the coolant temperature of the engine drops gradually from the point in time tb onwards. However, the engine coolant temperature immediately after stop is comparatively high, and hence a temperature Tinj of the tip of the fuel injection valve rises gradually on account of the radiant heat from the intake valve and so forth, as explained above on the basis of FIG. 3. When the engine stops (control flag ON (step S509)), the lift amount of the intake valve of each cylinder is calculated (step S511), and there is calculated the reduction correction factor Gk of the fuel injection amount for each cylinder, on the basis of the lift amount (step S513). As a result, “1” is calculated, as the correction factor Gkc, for cylinders #1, #2, #4, which are closed cylinders, and a value smaller than 1 (for instance, 0.3) is calculated as the correction factor Gknc, on the basis of the lift amount L of the intake valve, for cylinder #3 which is an open cylinder.

The temperature of the tip of the fuel injection valve rises in a state where there is no engine start request (negative determination in step S515). When the temperature of the tip of the fuel injection valve reaches the threshold value Ts at a point in time tc (affirmative determination in step S517), there is calculated a startup requested fuel amount Fst1 at the coolant temperature at the present time (tc) (step S519). The startup requested fuel amount Fst1 is calculated through searching of data given in FIG. 6, at the coolant temperature Tw1 at that time. The startup requested fuel amount Fst1 is corrected by the correction factor Gk of the cylinder, for each cylinder, and a corrected fuel amount CF1 (Fst1×Gk) is calculated (step S521). The correction factor Gkc of cylinders #1, #2, #4, which are closed cylinders, is “1”, and hence a corrected fuel amount CFc1 is calculated that is the startup requested fuel amount Fst1 itself. The temperature difference correction factor Gknc for cylinder #3, which is an open cylinder, is smaller than 1, and hence a corrected fuel amount CFnc1 is calculated that is smaller than the startup requested fuel amount Fst1.

This time is the first time, after engine stop, that the temperature of the tip of the fuel injection valve reaches the threshold value Ts during engine stop, and hence the stoppage fuel integrated amount is zero. Accordingly, the amount of cooling fuel Fc1 of cylinders #1, #2, #4, which are closed cylinders, is set to the corrected fuel amount CFc1, and the amount of cooling fuel Fnc1 of cylinder #3 is set to the corrected fuel amount CFnc1 (step S523). Then, fuel in the cooling fuel amounts thus set is injected through the fuel injection valve of each cylinder (step S525). The amount of cooling fuel that is injected is added to the stoppage fuel integrated amount (step S527). This time is the first time, after engine stop, that the temperature of the tip of the fuel injection valve reaches the threshold value Ts during engine stop, and hence the stoppage fuel integrated amount is the cooling fuel amount itself.

The amount of cooling fuel Fnc1 of cylinder #3 is made smaller, through correction, than the amount of cooling fuel Fc1 of cylinders #1, #2, #4. Therefore, the height of the fuel injection amount in FIG. 7 is depicted as being lower. The fuel injection amounts illustrated in FIG. 7 are depicted as heights of peaks the width of which has no special meaning. The fuel injection amount during operation of the engine is illustrated in FIG. 7 as having a constant height, but this merely indicates that the engine is running, and the heights in the figure have no special meaning.

Upon injection of the cooling fuel, the respective fuel injection valve is cooled by the fuel, and the temperature of the tip of the fuel injection valve drops. Deposit formation at the fuel injection valve is suppressed as a result. In the example of FIG. 7, however, the coolant temperature is still at a high temperature state, and hence the temperature of the tip of the fuel injection valve begins to rise on account of radiant heat from the wall faces of the intake port and the like. When the temperature of the tip of the fuel injection valve reaches once more threshold value Ts at a point in time td (affirmative determination in step S517), there is calculated a startup requested fuel amount Fst2 at a coolant temperature Tw2 at that time (step S519). There is also calculated a corrected fuel amount CF2 (=Fst2×Gk) using the reduction correction factor Gk. This time, the stoppage fuel integrated amount is Fc1 for cylinders #1, #2, #4, and Fnc1 for cylinder #3. Accordingly, the amount of cooling fuel Fc2 of cylinders #1, #2, #4 is set to a value (=CFc2−Fc1) resulting from subtracting the stoppage fuel integrated amount from the corrected fuel amount CFc2 (=Fst2×Gkc), while the amount of cooling fuel Fnc2 of cylinder #3 is set to a value (=CFnc2−Fnc1) resulting from subtracting the cooling fuel integrated amount from the corrected fuel amount CFnc2 (=Fst2×Gknc) (step S523). Then, fuel in the cooling fuel amounts thus set is injected through the fuel injection valve of each cylinder (step S525).

As can be gleaned from the explanation above, when the temperature of the tip of the fuel injection valve, after engine stop, reaches the threshold value Ts for the third time during engine stop, the amount of cooling fuel Fc3 of cylinders #1, #2, #4 is set to a value (=CFc3−(Fc1+Fc2)) resulting from subtracting the stoppage fuel integrated amount (Fc1+Fc2) from the corrected fuel amount CFc3 (=Fst3×Gkc), and the amount of cooling fuel Fnc3 of cylinder #3 is set to a value (=CFnc3−(Fnc1+Fnc2) resulting from subtracting the stoppage fuel integrated amount (Fnc1+Fnc2) from the corrected fuel amount CFnc3 (=Fst3×Gknc). Similarly, when the temperature of the tip of the fuel injection valve, after engine stop, reaches the threshold value Ts for the fourth time during engine stop, the amount of cooling fuel Fc4 of cylinders #1, #2, #4 is set to a value (=CFc4−(Fc1+Fc2+Fc3)) resulting from subtracting the stoppage fuel integrated amount (Fc1+Fc2+Fc3) from the corrected fuel amount CFc4 (=Fst4×Gkc), and the amount of cooling fuel Fnc4 of cylinder #3 is set to a value (=CFnc4−(Fnc1+Fnc2+Fnc3)) resulting from subtracting the stoppage fuel integrated amount (Fnc1+Fnc2+Fnc3) from the corrected fuel amount CFnc4 (=Fst4×Gknc). That is, when the temperature of the tip of the fuel injection valve, after engine stop, reaches the threshold value Ts for the n-th time during engine stop, the amount of cooling fuel Fcn of cylinders #1, #2, #4, which are closed cylinders, is set to a value (=CFcn−ΣFc(n−1)) resulting from subtracting the stoppage fuel integrated amount (ΣFc(n−1)) from the corrected fuel amount CFcn (=Tstn×Gkc)), and the amount of cooling fuel Fncn of cylinder #3, which is an open cylinder, is set to a value (=CFncc−ΣFnc(n−1)) resulting from subtracting the cooling fuel integrated amount (ΣFnc(n−1)) from the corrected fuel amount CFncn (=Fstn×Gknc).

In the example of FIG. 7, there is an engine start request at the point in time te, by which the number of times that the temperature of the tip of the fuel injection valve has reached the threshold value Ts is two times (affirmative determination in step S515). When there is an engine start request, a startup requested fuel amount Fste is calculated on the basis of the coolant temperature Twe at that a point in time te (step S529). The startup fuel injection amount is then calculated for each cylinder. The startup injection amount Fce of cylinders #1, #2, #4 is set to a value (=Fste−(Fc1+Fc2)) resulting from subtracting the stoppage fuel integrated amount (Fc1+Fc2) from the startup requested fuel amount Fste, and the startup injection amount Fnce of cylinder #3 is set to a value (=Fste−(Fnc1+Fnc2)) resulting from subtracting the stoppage fuel integrated amount (Fnc1+Fnc2) from the startup requested fuel amount Fste. The stoppage fuel integrated amount of closed cylinders is larger than the stoppage fuel integrated amount of open cylinders, and hence the startup injection amount Fce of cylinders #1, #2, #4 in FIG. 7 is lower than the startup injection amount Fnce of cylinder #3.

As described above, the amount of cooling fuel in open cylinders is smaller than the amount of cooling fuel in closed cylinders. In open cylinders, therefore, the degree to which fuel persists inside the open cylinder can be curtailed even if the fuel injection valve is cooled by cooling fuel injected through the fuel injection valve. Therefore, it becomes possible to suppress worsening of exhaust emissions that may occur when fuel that collects inside the open cylinder, in the compression stroke and expansion stroke of the open cylinder immediately after engine start, does not vaporize sufficiently and is discharged out through the exhaust passage. The present embodiment allows thus achieving cooling of fuel injection valves (deposit formation suppression) as well as preventing worsening of exhaust emissions.

The fuel flows into the cylinder, in the startup injection amount Fnce of the open cylinder at the time of engine startup, through lowering of the piston to the bottom dead center, in the intake stroke. Therefore, the inflowing fuel vaporizes more readily than fuel already collected within the cylinder. The tendency to combust upon ignition immediately after engine start is accordingly more pronounced. However, the startup injection amount Fnce of the open cylinder at the time of engine startup may be set to be yet smaller. For instance, the startup injection amount Fnce may be set to zero. The discharge of fuel from the open cylinder immediately after engine start can be further suppressed as a result in some instances. Such suppression-reduction in the startup injection amount may be applied also to the closed cylinders.

The invention has been explained above on the basis of embodiments, but the latter can be modified in various ways. An example of one such modification is explained next.

In cooling fuel injection control at engine stop in the above embodiment, the correction factor Gknc of an open cylinder is variably set on the basis of the lift amount of the intake valve of the open cylinder. However, the correction factor Gknc of the open cylinder can be set to zero or to a small value, regardless of the lift amount of the intake valve. By having the correction factor Gknc of the open cylinder set to zero, the cooling fuel amount of the open cylinder becomes accordingly zero, which allows preventing fuel from reaching the interior of the open cylinder during engine stop. In this case, the startup injection amount Fnce of the open cylinder may likewise be set to zero. By doing so it becomes possible to reliably prevent fuel from being discharged unburned, out of the open cylinder, immediately after engine start. The fuel injection valve cannot be cooled by fuel during engine stop when cooling fuel is not injected in the open cylinder during engine stop. However, there is a high likelihood that such a cylinder is selected, in step S503 above, as the cylinder with the smallest number of times that the intake valve thereof has been in a closed state at engine stop. It becomes accordingly possible to sufficiently suppress or prevent, even in that case, the occurrence and growth of deposits on the fuel injection valve of such a cylinder.

In a case where the engine is provided with an idling stop (idle reduction) system, the above-described control scheme for cooling of the fuel injection valves may also be used during idling stop (idle reduction). The idling stop system executes idling stop (stops the engine) if there is met a pre-set first execution condition for the state of the vehicle while the latter is stopped. The idling stop system (re)starts the engine when a second execution condition is met. The first execution condition is, for instance, a condition that stipulates a brake-on state (brake pedal depressed) with the vehicle stopped (zero vehicle speed). The first execution condition may be a condition that stipulates the passage of a predetermined lapse of time since the vehicle stops. The second execution condition may stipulate, for instance, that at least one of the following be satisfied: a state where brake-on has been cancelled, non-zero vehicle speed, and accelerator pedal depressed. The brake state can be detected on the basis of a signal from a device (for instance, a brake lamp switch) that detects the depression state of the brake pedal. Whether or not the vehicle is stopped can be detected on the basis of a signal from a vehicle speed sensor. The ECU above can assume the control function as an idling stop system. In step S505 above it may be determined that there is an engine stop request when the engine is stopped, by the idling stop system, in that the first execution condition is satisfied. In step S515 it may be determined that there is an engine start request when the engine is re-started, by the idling stop system, in that the second execution condition is satisfied.

The embodiments of the invention are not limited to the embodiments described above. The invention includes any and all variations, application examples, and equivalents, that are encompassed in the concept of the invention as defined in the appended claims.

What is claimed is:

1. A control device for an internal combustion engine, the internal combustion engine including a plurality of cylinders and fuel injection valves provided in respective intake ports of the cylinders, the control device comprising:
an electronic control unit configured to
a) execute first fuel injection control when a temperature of the fuel injection valve exceeds a predetermined temperature, at a time when the internal combustion engine is stopped; and
b) set a first fuel amount that is injected at the first fuel injection control such that an amount of fuel injected into an open cylinder is smaller than an amount of fuel injected into a cylinder other than the open cylinder, the open cylinder being a cylinder whose intake valve is in an open state when the internal combustion engine stops.

2. The control device according to claim 1, wherein the electronic control unit sets the amount of fuel injected into the open cylinder based on a state of opening the intake valve of the open cylinder.

3. The control device according to claim 1, wherein
the electronic control unit sets a second fuel amount requested at startup of the internal combustion engine based on a coolant temperature of the internal combustion engine, and
the electronic control unit sets the first fuel amount such that the first fuel amount is equal to or smaller than the second fuel amount.

4. The control device according to claim 1, wherein the electronic control unit sets the first fuel amount such that, in each of the cylinders, the first fuel amount is equal to or smaller than a difference between the second fuel amount and a fuel amount that has already been injected through the fuel injection valve of the cylinder during a current stop of the internal combustion engine.

5. The control device according to claim 1, wherein the electronic control unit sets the first fuel amount of the open cylinder such that inflow of fuel into the open cylinder is suppressed when the internal combustion engine stops.

6. The control device according to claim 5, wherein the electronic control unit sets the first fuel amount of the open cylinder to zero.

7. The control device according to claim 3, wherein
the electronic control unit sets a third fuel amount that is injected at startup of the internal combustion engine such that the third fuel amount in each of the cylinders is equal to or smaller than a difference between the second fuel amount and a fuel amount that has already been injected through the fuel injection valve of the cylinder during a current stop of the internal combustion engine when a start request is made to the internal combustion engine; and
the electronic control unit controls fuel injection through the fuel injection valve such that fuel is injected with the third fuel amount thereby starting the internal combustion engine.

8. The control device according to claim 1, wherein the electronic control unit operates a spark plug of each of the cylinders at least at one of an initial compression stroke and an initial expansion stroke of each of the cylinders when the internal combustion engine is started.

9. The control device according to claim 1, wherein
the electronic control unit stores the number of times that the intake valve is in a closed state at stop of the internal combustion engine for each of the cylinders, and
the electronic control unit performs control of stopping the internal combustion engine such that the intake valve of the cylinder is brought to a closed state when the internal combustion engine stops, the intake valve being in the closed state at stop of the internal combustion engine the smallest number of times.
